(19) United States
(12) Patent Application Publication
(10) Pub. No.: US 2026/0328365 A1
(43) Pub. Date: Oct. 22, 2026

(54) ILLUMINATED EMBLEM

(71) Applicant: TOYODA GOSEI CO., LTD., Kiyosu-shi (JP)

(72) Inventors: Yoshihide NODA, Kiyosu-shi (JP); Hirotaka FUKUI, Kiyosu-shi (JP); Yuki GOTO, Kiyosu-shi (JP)

(21) Appl. No.: 19/629,034

(22) Filed: Mar. 26, 2026

(30) Foreign Application Priority Data
Apr. 17, 2025 (JP) 2025-068210

(51) Int. Cl. F21S 43/50; F21S 43/14; F21S 43/241; F21S 43/40; G09F 13/04; F21W 104/00

(52) U.S. Cl. CPC F21S 43/50; F21S 43/14; F21S 43/241; F21S 43/401; G09F 13/044; F21W 2104/00

(57) ABSTRACT

An illuminated emblem includes an outer lens constituting an emblem design, a housing, a light-emitting element that is housed in a space sealed by the housing and the outer lens and emits light toward the outer lens, and a light guide layer that is provided so as to cover the light-emitting element and therearound and guides light from the light-emitting element in a direction intersecting an optical axis of the light-emitting element. An air layer is formed between the outer lens and the light guide layer.

### CROSS-REFERENCE TO RELATED APPLICATIONS

The present patent application claims the priority of Japanese patent application No. 2025/068210 filed on Apr. 17, 2025, and the entire contents of Japanese patent application No. 2025/068210 are hereby incorporated by reference.

### TECHNICAL FIELD

The present invention relates to an illuminated emblem, in particular, to an illuminated emblem installed on a vehicle such as automobile.

### BACKGROUND ART

Illuminated emblems that light up emblem designs are known. For example, Patent Literature 1 discloses an illuminated emblem that achieves uniform light emission by individually controlling the light-emitting state of plural LEDs used as light sources.

### Citation List

### Patent Literature

Patent Literature 1: JP 2024/4826 A

### SUMMARY

In recent years, illuminated emblems have become increasingly thinner, and there are cases where there is no place to conceal the light source due to restriction by the design of the emblem. In such cases, reducing the thickness of the illuminated emblem results in an extremely short distance from the light source to the outer lens having the emblem design. This causes a problem in that light concentrates directly above the light source. This results in uneven brightness or variations in light emission color depending on locations, hence, improvements are desired. In addition, in case of individually controlling the light-emitting state of LEDs as in Patent Literature 1, there is also a problem in that the power cost increases.

It is an object of the invention to provide an illuminated emblem that suppresses concentration of light directly above a light source and achieves uniform light emission while keeping power costs down.

One aspect of the invention provides the following illuminated emblem.

(1) An illuminated emblem, comprising:
an outer lens constituting an emblem design;
a housing;
a light-emitting element that is housed in a space sealed by the housing and the outer lens and emits light toward the outer lens; and
a light guide layer that is provided so as to cover the light-emitting element and therearound and guides light from the light-emitting element in a direction intersecting an optical axis of the light-emitting element,
wherein an air layer is formed between the outer lens and the light guide layer.
(2) The illuminated emblem as defined in 1 , wherein the outer lens is thicker than the air layer, and wherein the light guide layer is thicker than the outer lens.
(3) The illuminated emblem as defined in (1), wherein a maximum roughness height Rz of a surface of the light guide layer opposite to a light-emitting surface of the light-emitting element is not less than 10 μm and not more than 12 μm.
(4) The illuminated emblem as defined in (1), further comprising:
   a light adjustment layer provided between the light guide layer and the outer lens,
   wherein the light adjustment layer comprises a light-transmitting portion that transmits light from the light-emitting element, and a light-adjusting portion to adjust brightness or color of the light.
(5) The illuminated emblem as defined in (4), wherein the light adjustment layer comprises a light-adjusting film formed by printing a pattern to adjust brightness or color of light from the light-emitting element on a film main body that transmits the light.
(6) The illuminated emblem as defined in (4), wherein the light adjustment layer comprises a decorative layer comprising a pattern to adjust brightness or color of the light that is formed on an inner wall of the outer lens, and wherein in the decorative layer, a portion not including the pattern constitutes the light-transmitting portion and a portion with the pattern constitutes the light-adjusting portion.
(7) The illuminated emblem as defined in (4), wherein the light adjustment layer is configured to comprise a predetermined repeating pattern of the light-transmitting portions or the light-adjusting portions, and a proportion of the light-transmitting portion increases and a proportion of the light-adjusting portion decreases as a distance from the light-emitting element increases.

(8) The illuminated emblem as defined in (1), further comprising:
a reflective layer that is provided on the inner wall of the outer lens on a lateral side and reflects light from the light-emitting element.

(9) The illuminated emblem as defined in (1), wherein the light-emitting element, a substrate on which the light-emitting element is mounted, and the light guide layer are formed in an integrated manner.

### Advantageous Effects of Invention

According to an exemplary embodiment of the invention, it is possible to provide an illuminated emblem that suppresses concentration of light directly above a light source and achieves uniform light emission while keeping power costs down.

### BRIEF DESCRIPTION OF DRAWINGS

FIG. 1 is a plan view showing an illuminated emblem in an embodiment of the present invention.

FIG. 2A is a cross-sectional view showing an example of a vertical cross-section of the illuminated emblem taken along line A-A shown in FIG. 1.

FIGS. 2B and 2C are plan views showing examples of a light-adjusting film.

FIGS. 3A-3C are plan views showing modifications of the light-adjusting film.

FIGS. 4A-4C are cross-sectional views showing vertical cross-sections of the illuminated emblems in modifications of the invention.

FIG. 5 is a cross-sectional view showing a vertical cross-section of the illuminated emblem in a modification of the invention.

FIG. 6 is a cross-sectional view showing a vertical cross-section of the illuminated emblem in a modification of the invention.

### DESCRIPTION OF EMBODIMENTS

### Configuration of an illuminated emblem

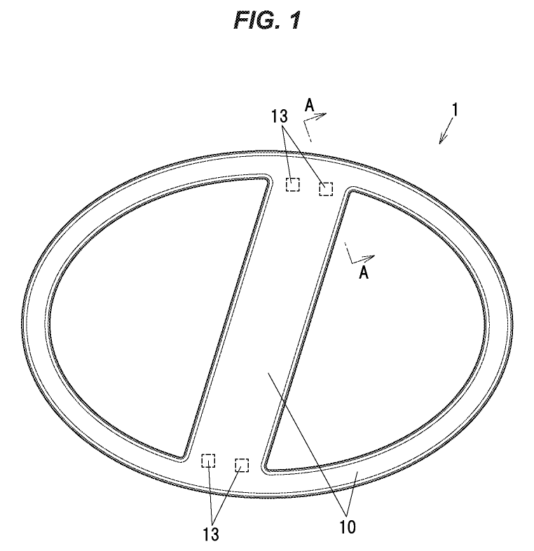

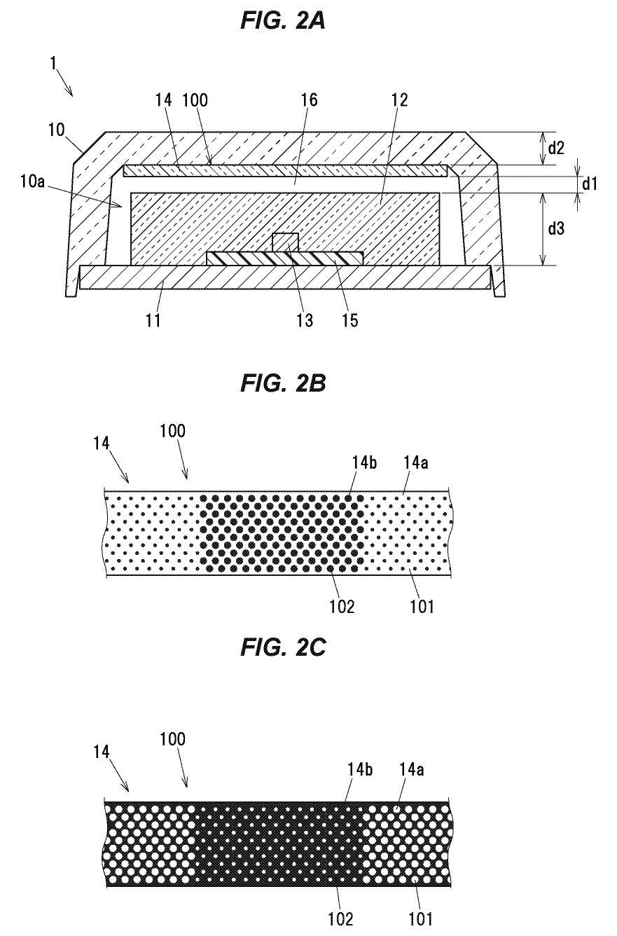

FIG. 1 is a plan view showing an illuminated emblem 1 in an embodiment of the invention. FIG. 2A is a cross-sectional view showing an example of a vertical cross-section of the illuminated emblem 1 taken along line A-A shown in FIG. 1.

The illuminated emblem 1 includes an outer lens 10 constituting an emblem design, a housing 11, light-emitting elements 13 as light sources, a light guide layer 12, an air layer 16, and a light adjustment layer 100. In the illuminated emblem 1, light emitted from the light-emitting elements 13 is extracted from a surface of the outer lens 10, causing the emblem design to be illuminated.

The outer lens 10 is formed of, e.g., a resin such as PMMA (methyl methacrylate) or PC that transmits the light emitted from the light-emitting elements 13. The outer lens 10 may include a diffusing material such as TiO2 particles to improve the uniformity of light extracted from the surface thereof. The outer lens 10 may be transparent or milky white in color. The illustrated example shows a case where the emblem design is a mark consisting of a combination of an elliptical frame and an I-shape. However, the emblem design is not limited to that shown in the drawing and can be changed as appropriate.

The outer lens 10 has a recessed space 10a therein, and is configured to house the light-emitting elements 13, the light guide layer 12 and the light adjustment layer 100 in this space 10a. The space 10a is formed to have an opening on an installation surface side of the illuminated emblem 1 (on the lower side in FIG. 2A).

The housing 11 is formed in a plate shape and is placed to close the opening of the space 10a of the outer lens 10 and seal the space 10a. The housing 11 is formed of, e.g., ASA (acrylonitrile-styrene-acrylic ester), ABS (acrylonitrile-butadiene-styrene) + PC (polycarbonate), or AES (acrylonitrile-ethylene-propylene-diene-styrene).

The light-emitting elements 13 are housed in the space 10a that is sealed by the housing 11 and the outer lens 10. LED is typically used as the light-emitting element 13. The light-emitting elements 13 are mounted on a printed circuit board 15 which is fixed to a surface of the housing 11 (the surface adjacent to the space 10a) such that the surface with the light-emitting elements 13 mounted thereon faces toward the outer lens 10. The printed circuit board 15 corresponds to the substrate of the invention. The optical axis of the light-emitting elements 13 is along a direction normal to the surface of the housing 11 (or an installation surface of the illuminated emblem 1), and the light-emitting elements 13 emit light toward the outer lens 10.

The light guide layer 12 is provided so as to cover the light-emitting elements 13 and the periphery thereof and guides light from the light-emitting elements 13 in a direction intersecting the optical axis of the light-emitting elements 13 (in this example, mainly in a direction perpendicular to the optical axis). The light guide layer 12 is formed of, e.g., a resin that transmits light emitted from the light-emitting elements 13, such as PMMA or PC. By including the light guide layer 12, light from the light-emitting elements 13 can be guided to portions of the outer lens 10 located away from the light-emitting elements 13, thereby making light emission of the illuminated emblem 1 uniform. In this regard, the light guide layer 12 may be milky white in color to diffuse the light, or may be colored in a predetermined color.

In the present embodiment, the light guide layer 12 is provided so as to cover the light-emitting elements 13 and the printed circuit board 15. The light guide layer 12 is formed, e.g., by molding a resin with the light-emitting elements 13 and the printed circuit board 15 inserted. Therefore, the light guide layer 12, the light-emitting elements 13 and the printed circuit board 15 are formed in an integrated manner. The light-emitting elements 13 are in the state of being sealed with the light guide layer 12. By integrating the light guide layer 12, the light-emitting elements 13 and the printed circuit board 15, it is possible to reduce the parts count and improve work efficiency in assembling the illuminated emblem 1.

The air layer 16 is provided around the light guide layer 12, i.e., between the outer lens 10 and the light guide layer 12. This air layer 16 is, in other words, the space 10a between the outer lens 10 and the light guide layer 12. Since the air layer 16 is present around the light-guiding layer 12, light is reflected at the interface between the light guide layer 12 and the air layer 16 and is guided.

By providing the light guide layer 12 so as to cover the light-emitting elements 13, light emitted from the lateral sides of the light-emitting elements 13 can also be guided, and the light emission of the illuminated emblem 1 can be made more uniform. In addition, when providing the light guide layer 12 so as to cover the light-emitting elements 13, the light guide layer 12 can be formed relatively thick even if the entire illuminated emblem 1 is thin, hence, it is possible to suppress concentration of light directly above the light-emitting elements 13 and achieve uniform light emission.

The outer lens 10 is preferably thicker than the air layer 16, and the light guide layer 12 is preferably thicker than the outer lens 10. That is, a thickness d1 of the air layer 16, a thickness d2 of the outer lens 10 and a thickness d3 of the light guide layer 12 preferably satisfy the relationship d1 < d2 < d3. More preferably, the thickness d2 of the outer lens 10 is not less than 2.5 times and not more than 3.5 times the thickness d1 of the air layer 16, and the thickness d3 of the light guide layer 12 is not less than 3.5 times and not more than 4.5 times the thickness d1 of the air layer 16. The thickness ratio d1:d2:d3 here is 1:3:4.

It should be noted that not all the light from the light-emitting elements 13 is guided by the light guide layer 12, and some of the light from the light-emitting elements 13 passes through the light guide layer 12 and enters the outer lens 10 directly above the light-emitting elements 13. Therefore, in the illuminated emblem 1 in which the distance between the light-emitting elements 13 and the outer lens 10 is extremely short due to further reduction in thickness, brightness directly above the light-emitting elements 13 may become excessively strong even when the light guide layer 12 is provided, which may cause so-called spotty or patchy light or unevenness in the light emission color.

Therefore, in the present embodiment, the light adjustment layer 100 to adjust brightness or light emission color is provided between the light guide layer 12 and the outer lens 10. The light adjustment layer 100 is provided (at a position intersecting the optical axis of the light-emitting element 13) so as to cover at least the area directly above the light-emitting element 13. In the present embodiment, the light adjustment layer 100 is composed of a light-adjusting film 14 adhered to a back surface of the outer lens 10 (an inner surface on the space 10a side). The light-adjusting film 14 can be adhered using, e.g., an adhesive or double-sided tape.

FIG. 2B is a plan view showing an example of the light-adjusting film 14 constituting the light adjustment layer 100. The light adjustment layer 100 has light-transmitting portions 101 that transmit light from the light-emitting element 13, and light-adjusting portions 102 to adjust the brightness or color of the light. The light-adjusting film 14 used as the light adjustment layer 100 in the present embodiment is formed by printing a pattern to adjust the brightness or color of light from the light-emitting element 13 (hereinafter referred to as the printed pattern) on a film main body that transmits the light. Hereinafter, a portion where no printing is applied and the film main body is exposed will be referred to as an exposed portion 14a, and a portion where printing is applied will be referred to as a printed portion 14b. When the light-adjusting film 14 is used as the light adjustment layer 100, the exposed portion 14a constitutes the light-transmitting portion 101 and the printed portion 14b constitutes the light-adjusting portion 102.

By appropriately adjusting the printed pattern on the light-adjusting film 14 that is provided directly above the light-emitting element 13, the brightness or color of light transmitted through the light-adjusting film 14 can be appropriately adjusted. Therefore, it is possible to further suppress the concentration of light directly above the light-emitting element 13 serving as the light source, thereby achieving uniform light emission and uniform light color.

In this example, the exposed portion 14a (i.e., the film main body) is transparent to light from the light-emitting element 13 (i.e., visible light). However, it is not limited thereto, and the exposed portion 14a (i.e., the film main body) may be configured to be milky white in color containing a diffusing material to diffuse light from the light-emitting element 13.

In the present embodiment, the printed portion 14b is black in color to block light from the light-emitting element 13. The printed portion 14b blocks part of light from the light-emitting element 13 and reduces the brightness of the area where the light concentrates, thereby making the emission light of the illuminated emblem 1 uniform. However, it is not limited thereto, and the printed portion 14b may transmit a portion of light from the light-emitting element 13, or may be colored in a predetermined color to adjust the light emission color. This suppresses unevenness in the light emission color, allowing for more uniform light emission of the illuminated emblem 1. In this regard, to adjust the brightness (i.e., to make the light emission uniform), it is preferable that the transmittance of light from the light-emitting element 13 be lower through the printed portion 14b than through the exposed portion 14a.

It is preferable that printing be applied so that the light-adjusting film 14 has a predetermined repeating pattern of either the exposed portions 14a (the light-transmitting portions 101) or the printed portions 14b (the light-adjusting portions 102). In the present embodiment, as shown in FIG. 2B, the light-adjusting film 14 is formed to have a repeating dot pattern of the printed portions 14b. The illustrated example shows a printed pattern in which the circular printed portions 14b forming a dot pattern are arranged in a staggered manner, but the printed pattern may be such that, e.g., the circular printed portions 14b are arranged at equal intervals vertically and horizontally rather than in a staggered manner. By adjusting the area ratio of the exposed portion 14a to the printed portion 14b in the light-adjusting film 14, the brightness or light emission color can be appropriately adjusted. To suppress unevenness in brightness or color, the size of the printed portion 14b (the size of the dot) is desirably as small as possible. The distance between the printed portions 14b (i.e., the distance between the dots) should be adjusted appropriately to achieve appropriate brightness and light emission color, taking into consideration the size of the printed portion 14b and the brightness of the incident light from the light-emitting element 13, etc.

Here, light from the light-emitting element 13 is most intense directly above the light-emitting element 13 and becomes weaker as the distance from the light-emitting element 13 increases. Therefore, to make light emission of the illuminated emblem 1 more uniform, the printed pattern on the light-adjusting film 14 is preferably set such that the proportion of the exposed portion 14a (the light-transmitting portion 101) increases and the proportion of the printed portion 14b (the light-adjusting portion 102) decreases as the distance from the light-emitting element 13 increases. In the example in FIG. 2B, the ratio of the exposed portion 14a to the printed portion 14b is changed by changing the size of the printed portion 14b, with a regular arrangement of dots which are the printed portions 14b. However, it is not limited thereto, and the ratio of the exposed portion 14a to the printed portion 14b may be changed by, e.g., changing the number of the printed portions 14b (i.e., the density), with the same size of the printed portion 14b. The ratio of the exposed portion 14a to the printed portion 14b may change gradually with the distance from the light-emitting element 13, or may change stepwise.

The example in which the light-adjusting film 14 is configured to have a dot pattern of the printing portions 14b has been described in FIG. 2B, but the light-adjusting film 14 can be configured such that the exposed portions 14a and the printed portions 14b are the other way round and the exposed portions 14a form a dot pattern, as shown in FIG. 2C.

### Modifications

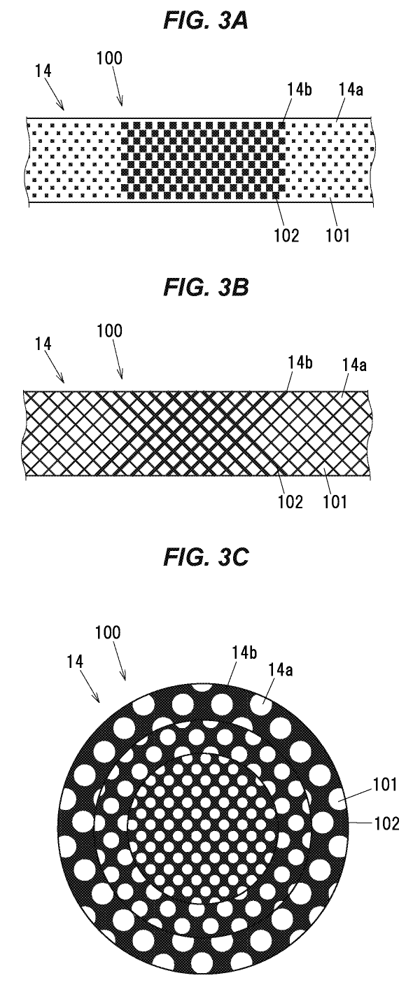

The example in which the printed pattern on the light-adjusting film14 is a dot pattern has been described in the present embodiment, but it is not limited thereto. For example, as shown in FIG. 3A, the shape of the printed portion 14b may be a rectangular shape. Alternatively, the shape of the printed portion 14b may be a triangular shape, an elliptical shape, a rhomboid shape, a polygonal shape, etc., even though it is not shown in the drawing. Furthermore, the printed portion 14b may be, e.g., in a lattice pattern as shown in FIG. 3B. It is obvious that the exposed portions 14a and the printed portions 14b in FIGS. 3A and 3B also can be the other way round.

Alternatively, as shown in FIG. 3C, the pattern on the light-adjusting film 14 may be formed such that the ratio of the exposed portion 14a to the printed portion 14b gradually increases concentrically (i.e., the ratio of the light-transmitting portion 101 to the light-adjusting portion 102 gradually increases) as the distance from the light-emitting element 13 increases. In FIG. 3C, the pattern is formed such that the area is divided into concentric circles centered about the position facing the light-emitting element 13 and the dots constituting the exposed portions 14a have a larger size in an area farther from the light-emitting element 13.

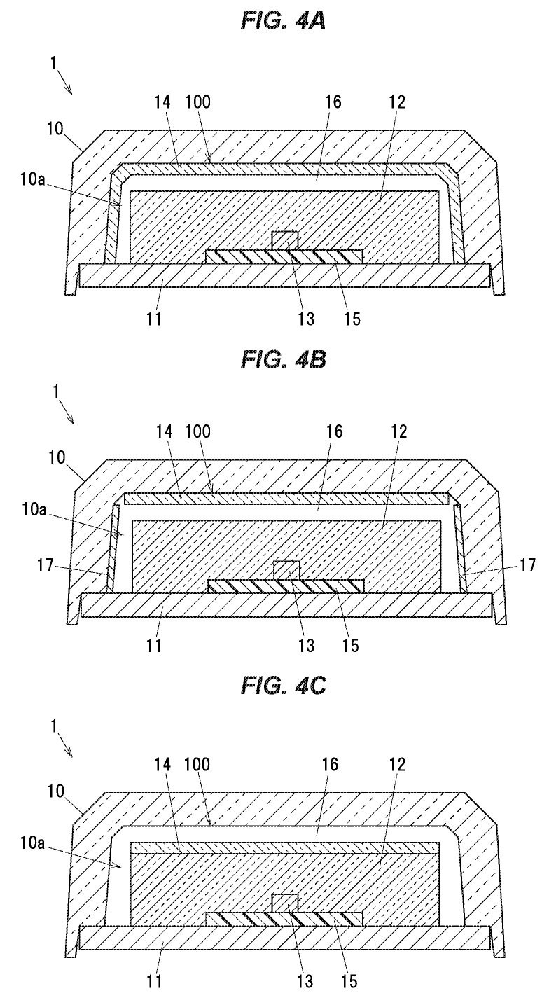

In addition, in the present embodiment, since the lateral surfaces of the illuminated emblem 1 are formed by the outer lens 10, it is conceivable that light from the light-emitting element 13 may concentrate at the lateral surfaces. In such a case, by providing the light-adjusting film 14 on the inner wall of the outer lens 10 on the lateral side as shown in FIG. 4A, it is possible to make the light emission more uniform and suppress spotty or patchy light, etc. caused by lateral emission of light from the light-emitting element 13. In this case, the light-adjusting film 14 may be shaped in advance to fit the inner surface of the outer lens 10, and the shaped light-adjusting film 14 may be attached to the inner surface of the outer lens 10.

Alternatively, as shown in FIG. 4B, a reflective layer 17 that reflects light from the light-emitting element 13 may be provided on the inner wall of the outer lens 10 on the lateral side. The reflective layer 17 is composed of, e.g., a metal film. Spotty or patchy light, etc. caused by lateral emission of light from the light-emitting element 13 can be suppressed also by providing the reflective layer 17. Furthermore, light exiting from the light guide layer 12 toward the lateral side can be reflected upward by providing the reflective layer 17.

Furthermore, although the light adjustment layer 100 is provided on the inner surface of the outer lens 10 in the present embodiment, it is not limited thereto. The light adjustment layer 100 may be provided on a surface of the light guide layer 12, as shown in FIG. 4C.

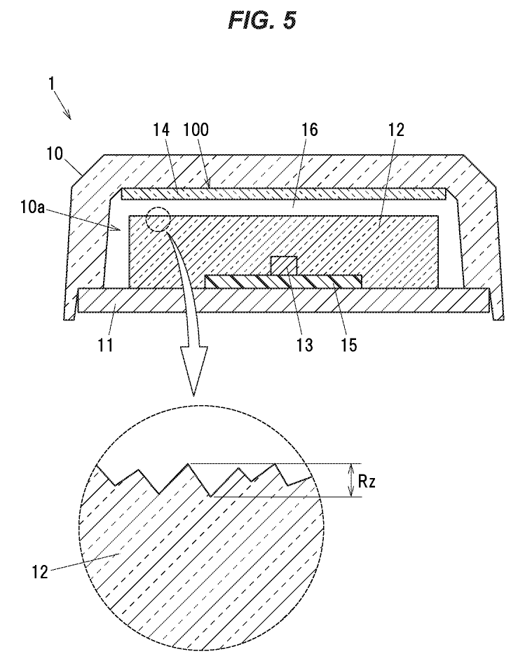

In addition, as shown in FIG. 5, the surface of the light guide layer 12 may be roughened so that light exiting from the light guide layer 12 is diffused, thereby making the light emission of the illuminated emblem 1 even more uniform. In this case, the maximum roughness height Rz of the surface (upper surface) of the light guide layer 12 opposite to the light emission surface of the light-emitting element 13 is preferably not less than 10 μm and not more than 12 μm. It is thereby possible to efficiently diffuse the light exiting from the light guide layer 12.

In addition, although the example in which the light guide layer 12 is formed by insert molding has been described in the present embodiment, the light guide layer 12 may be formed by another method. For example, the light guide layer 12 can be formed by extruding a resin such as silicone from above the printed circuit board 15 using a dispenser, etc., then depositing the extruded resin so as to cover the light-emitting elements 13, and curing the resin. In this case, since no mold is used, the illuminated emblem 1 can be manufactured without introducing special manufacturing equipment, etc. The light guide layer 12 does not need to have a rectangular cross-sectional shape and may have, e.g., a semicircular cross-sectional shape, and the cross-sectional shape is not particularly limited.

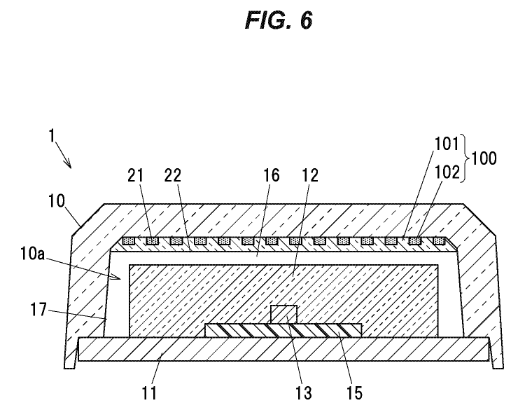

Furthermore, although the light-adjusting film 14 is used as the light adjustment layer 100 in the present embodiment, it is not limited thereto. In particular, as shown in FIG. 6, the light adjustment layer 100 may have a decorative layer 21 formed by providing a pattern to adjust the brightness or color of light on the inner wall of the outer lens 10 and may be configured such that a portion not including the pattern of the decorative layer 21 constitutes the light-transmitting portion 101 and a portion with the pattern constitutes the light-adjusting portion 102.

The decorative layer 21 is a layer corresponding to the printed portion 14b of the light-adjusting film 14. To form the decorative layer 21, e.g., a film is formed on the inner wall of the outer lens 10 by applying a coating or sputtering and a pattern is then formed by removing part of the film with a laser. However, the method for forming the decorative layer 21 is not limited thereto, and the decorative layer 21 may be formed by inkjet printing. Although the decorative layer 21 here is formed of a black pattern to block light from the light-emitting element 13, the decorative layer 21 may transmit a portion of light from the light-emitting element 13 or may be colored in a predetermined color to adjust the light emission color. The pattern of the decorative layer 21 can be the same as the pattern of the printed portion 14b of the light-adjusting film 14.

In addition, the light adjustment layer 100 may further include a protective layer 22 that is provided so as to cover the decorative layer 21 and protect the decorative layer 21. The protective layer 22 is a layer corresponding to the exposed portion 14a of the light-adjusting film 14. The protective layer 22 is transparent to light from the light-emitting element 13 (i.e., visible light) but may be, e.g., milky white in color or may be colored in a predetermined color to adjust the light emission color. The protective layer 22 also gets into the portions of the decorative layer 21 where the film has been removed, thereby filling in the irregularities of the decorative layer 21. In other words, the decorative layer 21 is embedded in the protective layer 22. By configuring the light adjustment layer 100 using the decorative layer 21 and the protective layer 22, problems such as misalignment of the light adjustment layer 100 relative to the outer lens 10 are less likely to occur.

### Effects of the embodiment

According to the illuminated emblem 1 in the embodiment of the invention, even if the distance between the outer lens 10 and the light-emitting elements 13 is short due to reduction in thickness, concentration of light directly above the light-emitting elements 13 can be suppressed by the light guide layer 12 provided so as to cover the light-emitting elements 13, thereby achieving uniform light emission. In addition, since the illuminated emblem 1 does not require individual control of the light-emitting elements 13, power costs can be reduced.

Although the embodiment of the invention has been described, the invention is not intended to be limited to the embodiment, and the various kinds of modifications can be implemented without departing from the gist of the invention. In addition, the constituent elements in the embodiment can be arbitrarily combined without departing from the gist of the invention. In addition, the invention according to claims is not to be limited to the above-mentioned embodiment. Further, please note that not all combinations of the features described in the embodiment are necessary to solve the problem of the invention.

### REFERENCE SIGNS LIST

1 ILLUMINATED EMBLEM
10 OUTER LENS
10a SPACE
11 HOUSING
12 LIGHT GUIDE LAYER
13 LIGHT-EMITTING ELEMENT
14 LIGHT-ADJUSTING FILM
14a EXPOSED PORTION
14b PRINTED PORTION
100 LIGHT ADJUSTMENT LAYER
101 LIGHT-TRANSMITTING PORTION
102 LIGHT-ADJUSTING PORTION

1. An illuminated emblem, comprising:
an outer lens constituting an emblem design;
a housing;
a light-emitting element that is housed in a space sealed by the housing and the outer lens and emits light toward the outer lens; and
a light guide layer that is provided so as to cover the light-emitting element and therearound and guides light from the light-emitting element in a direction intersecting an optical axis of the light-emitting element,
wherein an air layer is formed between the outer lens and the light guide layer.

2. The illuminated emblem according to claim 1, wherein the outer lens is thicker than the air layer, and wherein the light guide layer is thicker than the outer lens.

3. The illuminated emblem according to claim 1, wherein a maximum roughness height Rz of a surface of the light guide layer opposite to a light-emitting surface of the light-emitting element is not less than 10 μm and not more than 12 μm.

4. The illuminated emblem according to claim 1, further comprising:
a light adjustment layer provided between the light guide layer and the outer lens,
wherein the light adjustment layer comprises a light-transmitting portion that transmits light from the light-emitting element, and a light-adjusting portion to adjust brightness or color of the light.

5. The illuminated emblem according to claim 4, wherein the light adjustment layer comprises a light-adjusting film formed by printing a pattern to adjust brightness or color of light from the light-emitting element on a film main body that transmits the light.

6. The illuminated emblem according to claim 4, wherein the light adjustment layer comprises a decorative layer comprising a pattern to adjust brightness or color of the light that is formed on an inner wall of the outer lens, and wherein in the decorative layer, a portion not including the pattern constitutes the light-transmitting portion and a portion with the pattern constitutes the light-adjusting portion.

7. The illuminated emblem according to claim 4, wherein the light adjustment layer is configured to comprise a predetermined repeating pattern of the light-transmitting portions or the light-adjusting portions, and a proportion of the light-transmitting portion increases and a proportion of the light-adjusting portion decreases as a distance from the light-emitting element increases.

8. The illuminated emblem according to claim 1, further comprising:
a reflective layer that is provided on the inner wall of the outer lens on a lateral side and reflects light from the light-emitting element.

9. The illuminated emblem according to claim 1, wherein the light-emitting element, a substrate on which the light-emitting element is mounted, and the light guide layer are formed in an integrated manner.
